(19) United States
(12) Patent Application Publication
(10) Pub. No.: US 2016/0357414 A1
(43) Pub. Date: Dec. 8, 2016

(54) DISPLAYING A NETWORK OF RELATED ENTITIES

(71) Applicant: PolewardSky Ltd, Romford (GB)

(72) Inventor: James Robert Grant, Romford (GB)

(21) Appl. No.: 15/166,671

(22) Filed: May 27, 2016

(30) Foreign Application Priority Data
Jun. 2, 2015 (GB) 1509496.4

(51) Int. Cl. G06F 3/0484; H04L 12/24

(52) U.S. Cl. CPC G06F 3/04845; G06F 3/04842; G06F 3/04847; H04L 41/22

(57) ABSTRACT

A computer-implemented method for displaying a network of nodes in a display space of a graphical user interface is disclosed, where the nodes corresponding to a user and one or more other entities. The method comprises: calculating a location in the display space for a parent node corresponding to the user; retrieving one or more entities, each entity having a stored relationship with the user; for each retrieved entity: retrieving a stored relationship between the entity and the user, the stored relationship having an associated metric; calculating a display distance in the display space based on the metric of the stored relationship; and displaying, in the display space, a child node corresponding to the entity at the display distance from the parent node; receiving a first user input indicating the selection of a child node; receiving a second user input indicating a location in the display space; calculating an updated distance between the parent node and the indicated location; updating a stored relationship between the user and the entity corresponding to the child node based on the updated distance; and displaying the child node at the updated distance in the display space from the parent node.

### TECHNICAL FIELD

The present invention relates to improvements in the display of networks of related entities in a graphical user interface and methods for allowing a user to interact with such a network.

### BACKGROUND

The relationships between real-world entities, such as individuals or companies, have become increasingly central to the operation of computing systems. The inter-relationship between entities can be treated as a network. Each entity is a node and each relationship between entities is an edge in the network. In this manner, the relationships between real-world entities can be stored in a suitable format for use by computing systems.

Such a network can be displayed in a graphical user interface relative to a particular user. Most commonly, this would be relative to a user currently logged in to a computing system. In some cases, this is in the form of a list of entities related to the user. In this manner, the network is not shown to the user. In more complex arrangements, using a display space in a graphical user interface, the user is typically located in the centre of the display space, and the related entities are located around the user.

However, conventional approaches do not allow for entities to be displayed differentiated based on any features (such as type or quality) of the relationship between the user and the entity. This limits the usefulness of storing entity relationships in a network format.

There is therefore a need for improvements in displaying a network of related entities in a graphical user interface, and user interaction with such a network.

### SUMMARY

According a first aspect, there is provided a computer-implemented method for displaying a network of nodes in a display space of a graphical user interface, the nodes corresponding to a user and one or more other entities. The method comprises: calculating a location in the display space for a parent node corresponding to the user; retrieving one or more entities, each entity having a stored relationship with the user; for each retrieved entity: retrieving a stored relationship between the entity and the user, the stored relationship having an associated metric; calculating a display distance in the display space based on the metric of the stored relationship; and displaying a child node corresponding to the entity at the display distance in the display space from the parent node; receiving a first user input indicating the selection of a child node; receiving a second user input indicating a location in the display space; calculating an updated distance between the parent node and the indicated location; updating a stored relationship between the user and the entity corresponding to the child node based on the updated distance; and displaying the child node at the updated distance in the display space from the parent node. It will be appreciated that, unless the context requires, steps may be performed in any order. For example, the parent node may be displayed subsequent to the child nodes being displayed.

In this manner, features associated with a stored relationship between a user and an entity in a network can be conveniently displayed. Moreover, the user is able to update the nature of the stored relationship by interacting with the display. This provides the user with a convenient mechanism for correcting or altering a network of entities.

Although the presence of each child node implies a relationship between the parent node and one or more child nodes, it can be useful to visually display a link between the parent node and one or more of the child nodes. Accordingly, in some embodiments, the method further comprises displaying, in the display space, a network edge between the parent node and each child node based on the metric of the stored relationship between the user and the entity corresponding to the child node. The method may further comprise displaying, in the display space, a network edge between a first child node and one or more second child nodes based on a stored relationship between the entity corresponding to the first child node and the entity corresponding to the second child node. This allows the network of entities and the relationships between the entities to be displayed as a network comprising nodes and edges.

Calculating a display distance between the child node and the parent node may be done based on any conventional method for calculating a distance. However, in preferred embodiments, calculating the display distance comprises: calculating a preliminary distance based on the metric of the stored relationship; and calculating the display distance based on the preliminary distance and weighting information associated with the entity corresponding to the child node. The weighting information may comprise a measure of the interaction between the first entity and the second entity. The interaction may comprise messages between the entities. Calculating the display distance based on the preliminary distance and weighting information associated with the entity corresponding to the child node may comprise calculating a weight coefficient based on the weighting information; and calculating the display distance as the product of the weighting coefficient and the preliminary distance. In this manner, the display distance can be calculated based on a plurality of features of the relationship or the entity, thereby displaying additional information in the network in a convenient and efficient manner.

Each child node may be displayed in any suitable manner to show a node in the display space. However, it is preferable to show the child node in a manner which includes further features of the relationship. To this end, in preferred embodiments, displaying a child node comprises: calculating a node size based on the display distance; calculating a node shape based on a type of the entity associated with the child node; and displaying, in the display space, a child node corresponding to the entity having the calculated node size and node shape at the display distance from the parent node. The node size and shape may be calculated in either order. Displaying a child node may further comprise displaying node information, the node information comprising information corresponding to the entity associated with the child node.

In some embodiments, it is preferable to show additional entities in the network, even where there is no stored relationship between the user and the entity. These additional entities can be terms “auxiliary entities”. Thus, in preferred embodiments, the method further comprises: retrieving one or more auxiliary entities, each auxiliary entity not having a stored relationship with the user; and for each auxiliary entity: calculating a display distance; and displaying, in the display space, an auxiliary node corresponding to the auxiliary entity at the display distance from the parent node. Such an approach has a particular application, for example, in displaying entities that are a result of a search performed by the user on a set of entities.

Child nodes may be grouped depending on the particular application. In preferred embodiments, the display space comprises a plurality of zones; wherein each node is displayed in one of the zones. The zones may be contiguous and may be concentric around the parent node, each zone having a threshold, the threshold representing the minimum distance from the parent node to a corresponding child node within the zone. Each zone may have a corresponding limit as to the number of nodes within the zone. The method may further comprise: in response to calculating the display distance between the parent node and a child node: calculating the zone corresponding to the display distance; and if the number of nodes in the zone is at the corresponding limit for the zone, recalculating the threshold for the zone. In this manner, each child node can be categorised based on the relationship between the parent node and the child node. This allows actions to be performed conveniently on a group of child nodes which fall into a single category.

According to a second aspect, there is provided a system, comprising: a processor; a memory in communication with the processor, the memory comprising a database for storing relationships between entities; a display in communication with the processor, the display being configured to display a graphical user interface comprising a display space; and at least one user input device in communication with the processor, each user input device being configured to receive a user input from a user; wherein the processor is adapted to perform a method according to an aspect of the invention.

According to a third aspect, there is provided a computer-readable medium having one or computer-executable instructions stored thereon which, when executed by a computing device, cause the computing device to perform a method according to an aspect of the invention.

### BRIEF DESCRIPTION OF FIGURES

Examples of the present invention will now be described with reference to the accompanying drawings, in which:

FIG. 1 shows a computing device for performing methods in accordance with the present invention;

FIG. 2 shows an example method for displaying a network of entities accordingly to the present invention;

FIG. 3 shows an example of a network displayed in accordance with the method shown in FIG. 2;

FIG. 4 shows a preferred method for calculating a display distance for use with the method of FIG. 2;

FIG. 5 shows an example of a network displayed in accordance with the method shown in FIG. 4;

FIG. 6 shows a preferred method for displaying a child node for use with the method of FIG. 2 or 4;

FIG. 7 shows an example of a network displayed in accordance with the method shown in FIG. 6;

FIG. 8 shows a method for displaying auxiliary entities for use with the method of any of FIG. 2, 4 or 6;

FIG. 9 shows an example of a network displayed in accordance with the method shown in FIG. 8;

FIG. 10 shows a method for displaying zones in a display space in accordance with the method of any of FIG. 2, 4, 6 or 8;

FIG. 11 shows an example of a network displayed in accordance with the method shown in FIG. 10; and

FIG. 12 shows a method for a user to interact with a displayed network in accordance with the method of any of FIG. 2, 4, 6, 8 or 10.

### DETAILED DESCRIPTION OF THE INVENTION

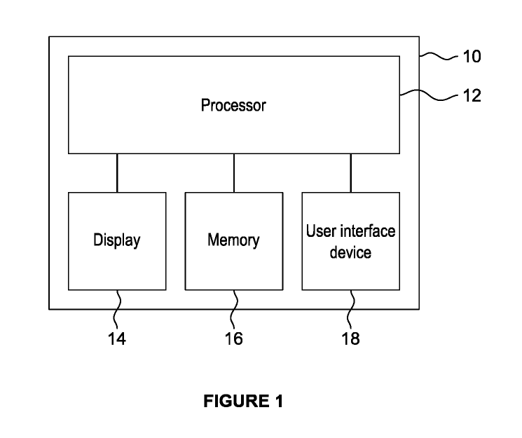

The present invention generally takes place on a computing device, such as computing device 10 shown in FIG. 1. Computing device 10 comprises at least one processor 12.

The processor 12 is in communication with a display 14. In use, the processor 12 causes the display 14 to display a graphical user interface. The graphical user interface may be configured to display a representation of a display space. The display space represents a space having a coordinate system in which one or more elements may be displayed. The display space may be two-dimensional. However, in some embodiments, the display space may be three-dimensional. For a three-dimensional display space, the display may be configured to display a two-dimensional representation of the three-dimensional displace space using conventional means.

The processor 12 is further in communication with a memory 16. The memory may comprise a database, and may be located remotely from the processor 12. In such cases, communication between the processor 12 and the memory 16 may take place by means of a network, such as the Internet.

The memory 16 is configured to store information related to a plurality of entities. In addition, the memory 16 is configured to store information related to relationships between pairs of the stored entities. In some cases, each relationship may be stored as an entry in a database which comprises a first identifier associated with a first entity and a second identifier associated with a second entity. It will be appreciated that the terms “entity” and “user” may refer both to the real-world entity and user, as well as their representations stored in the memory 16.

Each stored relationship has an associated metric which can have an associated magnitude. In some embodiments, the metric is a measure of the “closeness” between the user and the entity. For example, an entity who is a real-world friend with the user may have a metric with a greater value than an entity who is an acquaintance. In other embodiments, the metric may be a measure of trust between the users. A high level of trust may correspond to increased rights of the entity to access data of the user. The metric may alternatively represent the level of legal or contractual dependence between users.

The metric may revert to a default value (such as 0) over time. For example, the metric may decrement by an amount (such as 1) each day until it reaches the default value. Conversely, if the metric is below the default value, it may increment by an amount over time until it reaches the default value. This can therefore represent a decay of a relationship over time.

The processor 12 may be in communication with one or more user interface devices 18, such as a mouse or a keyboard. In some cases, the display 12 may additionally function as a user interface device, such as where the display 12 comprises a touchscreen.

In some embodiments, the present invention comprises a method for displaying a network of entities. Each entity can be displayed as a node. In this manner, the method can be realised as a method for displaying a network of nodes in the display space.

The network comprises at least two nodes. One node, which is termed the “parent node”, corresponds to a user, such as the currently logged in user. Each of the remainder of the nodes in the network, which are termed “child nodes”, corresponds to an entity. Preferably, each of the entities has a stored relationship with the user. The relationship may be stored in the database of the memory 16.

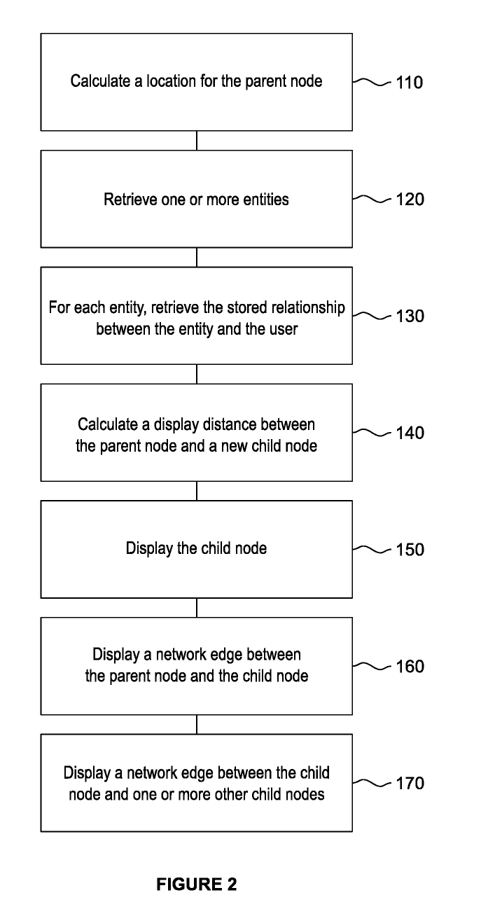

An example of a method for displaying a network of entities accordingly to the present invention is shown in FIG. 2.

At step 110, a location for the parent node, which corresponds to a user, in the display space is calculated. Preferably, the parent node is displayed in the display space at the calculated location. This may comprise displaying the parent node in the centre of the display space.

At step 120, one or more entities are retrieved. Each retrieved entity has a stored relationship with the user. Thus, retrieving the entities may comprise querying the database based on the user or an identifier associated with the user.

At step 130, for each of the retrieved entities, the stored relationship between the user and the entity is retrieved. A metric having a magnitude is associated with each stored relationship.

At step 140, based the stored relationship, a display distance in the display space between the parent node and a new child node, corresponding to the entity, is calculated. In some embodiments, the display distance is based on the metric associated with the stored relationship.

The display distance is typically formed in relation to the display space, and has the same unit as the dimensions of the display space. For example, where the display space is a two-dimensional space having a height and width in a number of pixels, the display distance may be a two-dimensional distance in pixels.

A mapping may exist between the metric and a display distance. The mapping may comprise a formula or algorithm which converts between the metric and the display distance.

The display distance need not be a scalar value, and may instead be a vector, such as a set of values for each dimension of the display space. For example, in a two-dimensional display space, the display distance may comprise a horizontal distance and a vertical distance. In another example, in a three-dimensional display space, the display distance may comprise a scalar distance in each of the x-, y- and z-axes.

At step 150, a child node corresponding to the entity is displayed in the display space at the calculated display distance from the parent node. The display distance may be calculated from the centre-point of the parent node and/or the child node.

The child node is also typically displayed at a display angle from the parent node. This can be randomly assigned, or may be calculated in relation to one or more other entities. To this end, the display angle may be calculated such that the child node is in the display space based on its relationship to other entities for which nodes are displayed in the display space. For example, if the child node has a stored relationship to a second child node that is already displayed, the child node may be displayed relatively near the second child node (though still at the display distance from the parent node).

At step 160, a network edge is displayed in the display space between the parent node and the child node. This may be based on the stored relationship between the user and the entity, and preferably is based on the metric associated with the stored relationship.

At step 170, a network edge is displayed in the display space between the child node and one or more second child nodes. This may be done based on a stored relationship between the entity corresponding to the child node and the entity corresponding to the second child node.

The network edge between two nodes (which may include the parent node) may be displayed as a line segment, having a thickness which is determined based on the metric associated with the stored relationship between the nodes.

In some embodiments, a further feature of the line segment (such as colour) may indicate a status of the relationship (such as whether both the user and the entity have confirmed the relationship). Additionally or alternatively, one or more icons may be shown at or adjacent to the line segment to indicate one or more other features of the relationship, for example whether a certain entity has been recorded as a “favourite” entity. These features may be alterable by the user by means of a suitable user interface mechanism.

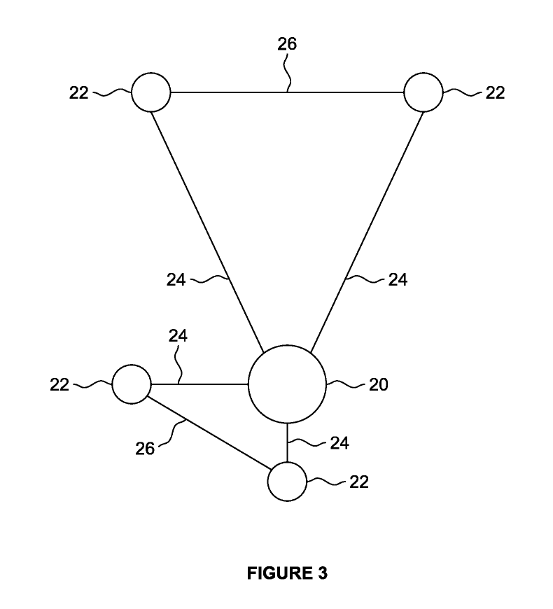

An example of a network displayed in accordance with the method of FIG. 2 is shown in FIG. 3. User 20 is displayed at the relative centre of a plurality of entities 22. A network edge 24 is shown between the user 20 and each entity 22. In addition, a network edge 26 is shown between some pairs of entities 22.

### Calculating Display Distances

A display distance may be calculated using a mapping from the metric associated with the stored relationship. However, in some cases the display may be calculated in association with weighting information.

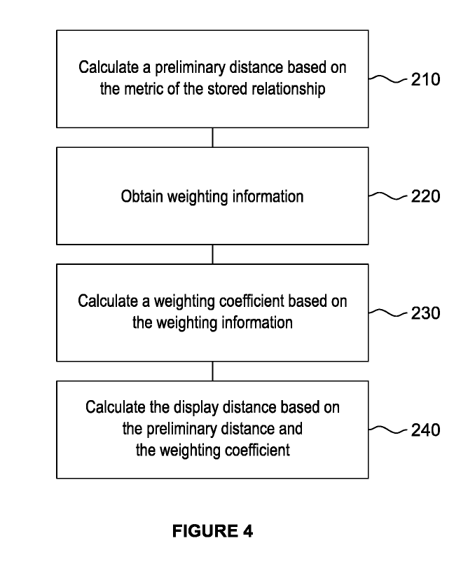

A preferred method for calculating a display distance at step 140 is shown in FIG. 4.

At step 210, a preliminary distance is calculated based on the metric associated with the stored relationship. This typically involves utilising the mapping between the metric and a display distance.

At step 220, weighting information associated with the entity corresponding to the child node is obtained from the memory. By way of example, the weighting information may comprise one or more of:

information related to interaction between the user and the entity associated with the child node, such as the number of messages between the users;

information related to groups that both the user and the entity belong to or are associated with;

information related to preferences of the user for the content of the entity;

information related to the physical location of the user and the entity;

information related to entities that are related to both the user and the entity (that is, shared relations); and

manually input weighting information.

At step 230, a weighting coefficient is calculated based on the weighting information. This may comprise using a formula or algorithm which compares the weighting information with that of a typical user. The weighting coefficient typically comprises a non-negative non-integer value, and is preferably less than or equal to 1.

At step 240, the display distance is calculated based on the preliminary distance and weighting coefficient. For example, the display distance may be calculated as the product of the preliminary distance and the weighting coefficient.

In this manner, the display distance provides a visual indication of ancillary information in addition to the metric associated with the stored relationship.

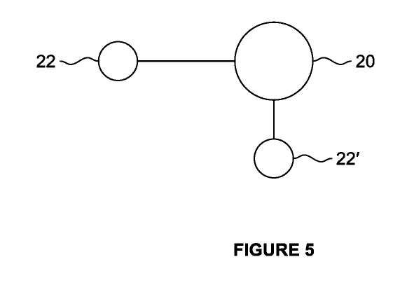

An example of a network displayed in accordance with the method of FIG. 4 is shown in FIG. 5. User 20 is displayed connected to an entity 22, where the display distance between user 20 and entity 22 is calculated in accordance with step 240. For the sake of understanding, an entity 22′ is also shown, where the display distance is equal to the preliminary distance. In use, entity 22′ would not be displayed.

### Displaying Child Nodes

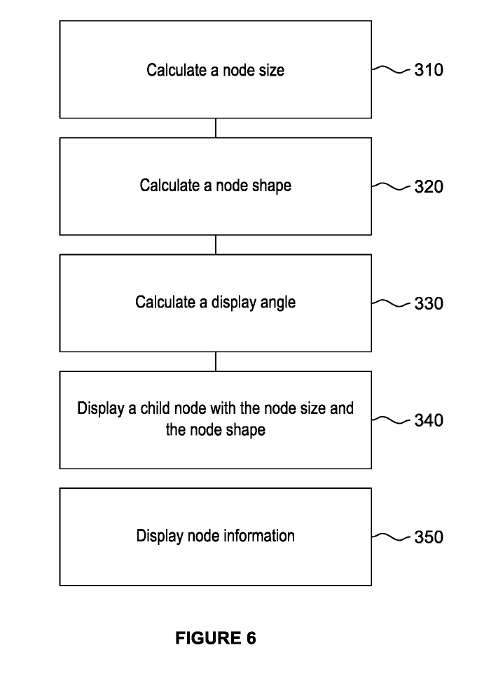

The child nodes displayed at step 150 may be displayed using any conventional method for displaying nodes. However, a preferred method for displaying a child node is shown in FIG. 6.

At step 310, a node size is calculated. This may be calculated based on the display distance. This may involve using a formula or which links display distance and node size, which may be subject to a minimum and maximum node size.

At step 320, a node shape is calculated. This may be calculated based on a type of the entity associated with the child node. For example, if the entity is an individual, a first shape may be chosen (such as a circle). If the entity is a business, a second shape may be chosen (such as a square).

At step 330, a display angle is calculated. This may be calculated based on the relationship between the entity and one or more other entities, or may be randomly assigned.

At step 340, a child node corresponding to the entity is displayed. The child node has the size of the calculated node size and the shape of the calculated node shape. It is located at the display distance from the parent node and at the display angle around the parent node.

At step 350, node information is displayed. The node information comprises information corresponding to the entity associated with the child node, for example a name or an image. This can be obtained from the memory. The information may be displayed next to the child node, or in another suitable manner to show a connection between the information and node. In some cases, the node information may be displayed inside the child node.

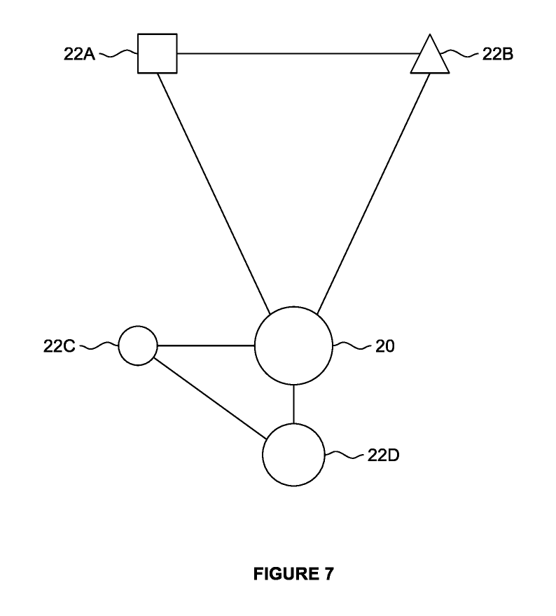

An example of a network displayed in accordance with the method of FIG. 6 is shown in FIG. 7. User 20 is displayed connected to entities 22A, 22B, 22C and 22D. Entity 22A is shown having a first shape and a first size. Entity 22B is shown having a second shape and the first size. Entity 22C is shown having a third shape and the first size. Entity 22D is shown having the third shape and a second size, in consideration of its smaller display distance.

### Auxiliary Entities

In some cases, it may be desirable to display entities in the network even where there is no relationship with the user. Such entities can be termed “auxiliary entities”. For example, if a user performed a search of entities matching certain terms, it may be useful to display nodes for each of these entities in the display space.

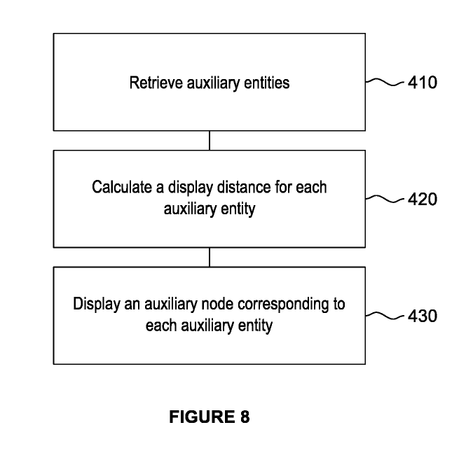

An example of a method for displaying auxiliary entities in connection with the present invention is shown in FIG. 8. The method of FIG. 8 can be performed after step 170 of the method of FIG. 2.

At step 410, one or more auxiliary entities are retrieved. This may comprise a predetermined set of auxiliary entities to display for all users. Alternatively or additionally, this may comprise a number of auxiliary entities which are algorithmically or randomly retrieved from a set of auxiliary entities stored in the memory.

At step 420, a display distance is calculated for each auxiliary entity. The display distance may be a default display distance.

At step 430, an auxiliary node corresponding to the auxiliary entity is displayed in the display space. The auxiliary node is displayed at the display distance from the parent node. The auxiliary node may be displayed in a similar manner to a child node.

In preferred embodiments, even if a network edge is shown between the parent node and child nodes, there is no network edge shown between the parent node and the auxiliary nodes. This reflects the lack of a stored relationship between the parent node and the auxiliary nodes.

An example of a network displayed in accordance with the method of

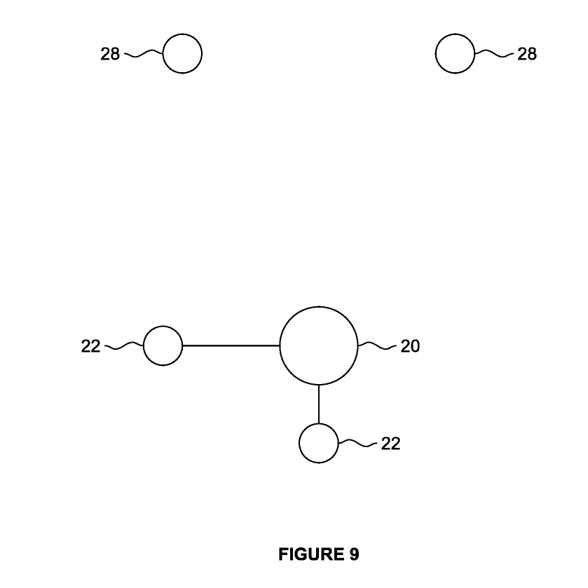

FIG. 8 is shown in FIG. 9. User 20 is shown connected to two entities 22. In addition, two auxiliary entities 28 are displayed, not connected to the user 20.

### Zones

Each stored relationship between the user and an entity has a metric associated with it. The metric may be mapped to one of a plurality of categories, each category having at least one of an upper and lower bound which define a range of values for the metric. Preferably every possible value for the metric maps to one category.

For example, the metric may represent a “closeness” of the user and the entity between 0 and 100. In such a case, when the metric falls within a first range, that is, is above a first value (such as greater than 70), the entity may be regarded as a “close friend”. When the metric falls within a second range, that is, it is below the first value but above a second value (such as above 40 but less than or equal to 70), the entity may be regarded as a “friend”. When the metric falls within a third range, that is, when it is below the second value, the entity may be regarded as an “acquaintance”.

Each category may have an entity limit associated with it. The entity limit represents the maximum number of entities which can be within the category. If the entity limit is exceeded, the upper bound or lower bound of the category may be adjusted such that the number of entities within the category is reduced.

In some embodiments, a plurality of contiguous zones are displayed in the display space. Each of the zones corresponds to a category. A child node is displayed in a particular zone if the metric associated with the stored relationship between the user and that child node is mapped to the category corresponding to that zone.

In addition, as noted above, there exists a mapping between the metric associated with the stored relationship and the display distance. This mapping may be used to calculate a display distance based on the stored relationship. Based on this, each zone maps to a range of values for the metric. In this manner, each zone will have a threshold which corresponds to the minimum display distance from the parent node for a child node to fall into that zone. Each threshold is equivalent to the lower bound of the range for the corresponding category. In this manner, the zones may be shown as a series of concentric circles around the parent node.

In some embodiments, category information, such as a name of the category, may additionally be displayed at or near the zone.

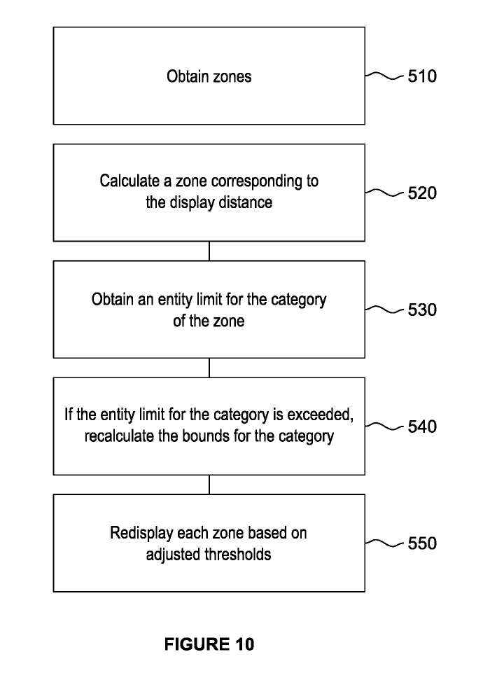

An example method for displaying zones in a display space is shown in FIG. 10.

At step 510, one or more contiguous zones are obtained. Each zone has a threshold corresponding to the minimum display distance from the parent node. Each zone is associated with one of the categories, such that the threshold for the zone is the lower bound for the associated category.

At step 520, in response to calculating the display distance between the parent node and the child node, the zone corresponding to the display distance is calculated.

At step 530, the entity limit for the category corresponding to the zone is obtained.

At step 540, if the entity limit for the category is exceeded, the lower bound and/or the upper bound for the category are recalculated. For example, one of the bounds may be increased or decreased until the number of entities in the category no longer exceeds the entity limit.

At step 550, the threshold for each zone is adjusted to be equal to the recalculated lower bound of the corresponding zone. Each zone is then redisplayed based on the adjusted threshold.

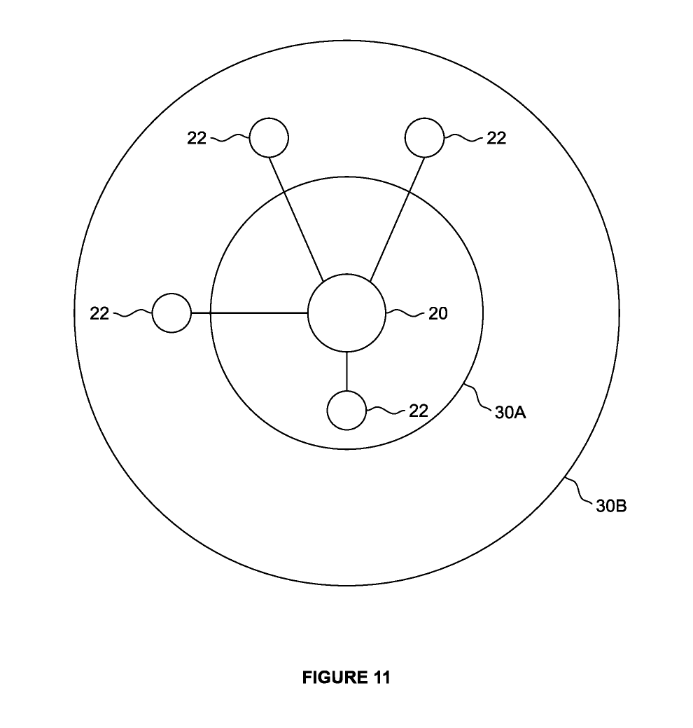

An example of a network displayed in line with the method shown in FIG. 10 is shown in FIG. 11. User 20 is shown connected to a plurality of entities 22. One entity 22 is shown within a first zone 30A. Three entities are shown within a second zone 30B.

### User Input

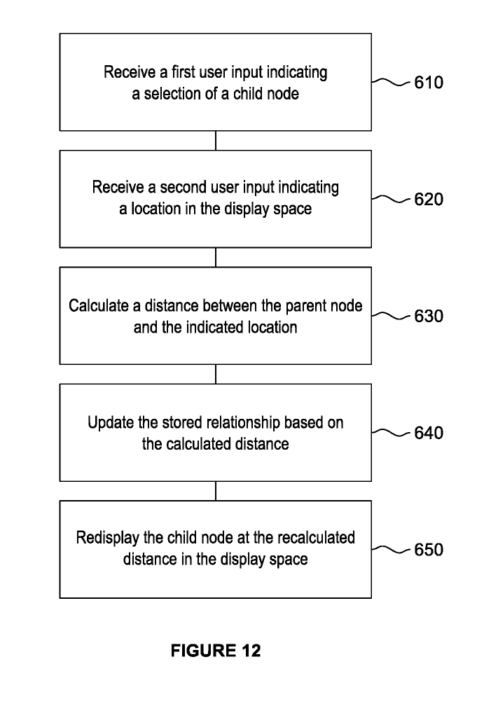

Once the network is displayed, in many cases it is useful to provide the user a mechanism to interact with the network. In particular, in use, the user is able to alter the stored relationship between the user and each entity. An example of a method for a user to interact with a displayed network is shown in FIG. 12.

At step 610, a first user input is received. The first user input indicates the selection of a child node. For example, the first user input may comprise the user clicking on a displayed node.

At step 620, a second user input is received. The second user input indicates a location in the display space. The second user input may be a continuation of the first user input. For example, after the user clicks on a first node as the first user input, the user may move the cursor and release the click on another location in the display space. This movement may be constrained along a particular axis, for example the axis defined by the display angle of the child node in relation to the parent node.

At step 630, a distance between the parent node (preferably the centre of the parent node) and the indicated location is calculated. For example, if the display space is two-dimensional, the distance may comprise a single value corresponding to the straight-line distance between the points.

At step 640, the stored relationship between the user and the entity corresponding to the child node is updated based on the calculated distance. In practice, this requires converting the display distance to a format suitable for the metric. This updated metric is then stored in the database.

At step 650, the child node is redisplayed in the display space. This typically follows the approach used at step 150. In effect, this means that that child node is displayed at the updated distance in the display space from the parent node.

In this manner, the user is able to reconfigure the relationship between the user and an entity.

### Trends

In use, there are many ways in which the metric associated with each relationship can be changed. For example, a change in the metric may occur as a function of time to model the decay in the relationship, as a result of a user input, or as the result of interaction between the user and the entity. In some embodiments, these changes are stored in the memory. In such embodiments, it is possible to identify trends that occur in the metric.

For example, if the metric of a certain relationship is generally decreasing (to represent a decrease in the “closeness” between the user and the entity), this can be identified as being a declining relationship. A prompt may be provided to the user to suggest one or more actions that could be taken to avoid further decline, for example suggesting that the user send a message to the entity.

In another example, if the metric of a relationship is generally increasing (to represent an increase in the “closeness” between the user and the entity), this can be identified as being an improving relationship. The user may then be prompted to move the entity into a different category, such as into the “close friend” category as opposed to the “acquaintance” category.

In some cases, one or more of the child nodes may have a graph displayed in the display space to show the trend of the relationship over time.

### Security

A particular application of the present invention is in the field of access management. It is common for different categories of users to have different levels of access to certain data. Data may include information, such as personal information related to a user, or may include electronic files or the like.

Each category may be associated with certain access rights. Typically the categories which have higher access rights to the user's data will be displayed as zones closer to the parent node. In this manner, if a child node is moved to a certain zone, the entity associated with that child node will be granted access rights corresponding to the category of the zone.

In practice, the user, such as a network administrator or superuser, is able to selectively change the rights associated with each category. A first user input is received identifying one or more displayed zones. The categories associated with each of the zones are then identified. A second user input indicating one or more access right changes is received. Based on the second user input, the access rights of each category can be updated.

Conversely, a user can set permissions for a certain piece of data based on the zones. The user is presented with a prompt to select one or more of the zones. A user input is then received indicated one or more of the zones. Based on this user input, the corresponding categories are identified. Access is then granted to those entities in the identified categories.

In this manner, access rights for entities within a network of entities can be set simply.

1. A computer-implemented method for displaying a network of nodes in a display space of a graphical user interface, the nodes corresponding to a user and one or more other entities, the method comprising:
calculating a location in the display space for a parent node corresponding to the user;
retrieving one or more entities, each entity having a stored relationship with the user;
for each retrieved entity:
retrieving a stored relationship between the entity and the user, the stored relationship having an associated metric;
calculating a display distance in the display space based on the metric of the stored relationship; and
displaying, in the display space, a child node corresponding to the entity at the display distance from the parent node;
receiving a first user input indicating the selection of a child node;
receiving a second user input indicating a location in the display space;
calculating an updated distance between the parent node and the indicated location;
updating a stored relationship between the user and the entity corresponding to the child node based on the updated distance; and
displaying the child node at the updated distance in the display space from the parent node.

2. The method of claim 1, further comprising:
displaying, in the display space, a network edge between the parent node and each child node based on the metric of the stored relationship between the user and the entity corresponding to the child node.

3. The method of claim 2, further comprising:
displaying, in the display space, a network edge between a first child node and one or more second child nodes based on a stored relationship between the entity corresponding to the first child node and the entity corresponding to the second child node.

4. The method of claim 1, wherein calculating the display distance comprises:
calculating a preliminary distance based on the metric of the stored relationship; and
calculating the display distance based on the preliminary distance and weighting information associated with the entity corresponding to the child node.

5. The method of claim 4, wherein the weighting information comprises a measure of the interaction between the first entity and the second entity.

6. The method of claim 5, wherein the interaction comprises messages between the entities.

7. The method of claim 4, wherein calculating the display distance based on the preliminary distance and weighting information associated with the entity corresponding to the child node comprises:
calculating a weight coefficient based on the weighting information; and
calculating the display distance as the product of the weighting coefficient and the preliminary distance.

8. The method of claim 1, wherein displaying a child node comprises:
calculating a node size based on the display distance;
calculating a node shape based on a type of the entity associated with the child node; and
displaying, in the display space, a child node corresponding to the entity having the calculated node size and node shape at the display distance from the parent node.

9. The method of claim 8, wherein displaying a child node further comprises:
displaying node information, the node information comprising information corresponding to the entity associated with the child node.

10. The method of claim 1, further comprising:
retrieving one or more auxiliary entities, each auxiliary entity not having a stored relationship with the user; and
for each auxiliary entity:
calculating a display distance; and
displaying, in the display space, an auxiliary node corresponding to the auxiliary entity at the display distance from the parent node.

11. The method of claim 1, wherein the display space comprises a plurality of zones, wherein each node is displayed in one of the zones.

12. The method of claim 11, wherein the zones are contiguous and are concentric around the parent node, each zone having a threshold, the threshold representing the minimum distance from the parent node to a corresponding child node within the zone.

13. The method of claim 12, wherein each zone has a corresponding limit as to the number of nodes within the zone.

14. The method of claim 13, further comprising:
in response to calculating the display distance between the parent node and a child node:
calculating the zone corresponding to the display distance; and
if the number of nodes in the zone is at the corresponding limit for the zone, recalculating the threshold for the zone.

15. A system, comprising:
a processor;
a memory in communication with the processor, the memory comprising a database for storing relationships between entities;
a display in communication with the processor, the display being configured to display a graphical user interface comprising a display space; and
at least one user input device in communication with the processor, each user input device being configured to receive a user input from a user;
wherein the processor is adapted to perform the method of any preceding claim.
